(19) United States
(12) Patent Application Publication
(10) Pub. No.: US 2025/0338995 A1
(43) Pub. Date: Nov. 6, 2025

(54) GASTRONORM PANS HEATING DEVICE

(71) Applicant: SEF TECH CO., LTD., Taipei City (TW)

(72) Inventors: HAN-CHING LO, Taipei City (TW); LUN-SHAN LIU, Taipei City (TW)

(21) Appl. No.: 18/653,322

(22) Filed: May 2, 2024

(51) Int. Cl. A47J 36/24

(52) U.S. Cl. CPC A47J 36/2483

(57) ABSTRACT

The gastronorm pans heating device includes a housing body, a rail, a plurality of elastic members, and a heating module that are disposed in the housing body. The housing body has an opening structure. The opening structure can be used to place a gastronorm pan in a predetermined position. The heating module includes a induction heating coil and a control circuit electrically coupled to the induction heating coil. The induction heating coil is disposed on the rail and can move along the rail, wherein the induction heating coil is supported by the elastic members, and the induction heating coil is held in the predetermined position to abut against the gastronorm pan by elastic force generated from the elastic members. The control circuit is electrically coupled to the induction heating coil, and the control circuit controls the induction heating coil to heat the gastronorm pan.

### FIELD OF THE DISCLOSURE

The present disclosure relates to a heating equipment, and more particularly to a gastronorm pans heating device.

### BACKGROUND OF THE DISCLOSURE

In order to ensure that the food in a gastronorm pan can be maintained to be at an ideal temperature for consumption and can be easily taken, buffet restaurants will place the gastronorm pan in a conventional gastronorm pans heating device. However, the conventional gastronorm pans heating device can only be used for gastronorm pans that only have a single size, and the size of the gastronorm pans cannot be adjusted according to the food sales volume.

### SUMMARY OF THE DISCLOSURE

In response to the above-referenced technical inadequacy, the present disclosure provides a gastronorm pans heating device.

In order to solve the above-mentioned problems, one of the technical aspects adopted by the present disclosure is to provide a gastronorm pans heating device. The gastronorm pans heating device includes a housing body, a rail, a plurality of elastic members, and at least one heating module. The housing body has an accommodation space and a height direction. The housing body has an opening structure that is in spatial communication with the accommodation space. The opening structure is configured to allow at least one gastronorm pan to be placed in a predetermined position. When the at least one gastronorm pan is located at the predetermined position, a top edge of the at least one gastronorm pan abuts against an outer edge of the opening structure, such that a part of the at least one gastronorm pan is accommodated in the accommodation space. The rail and the elastic members are disposed in the accommodation space. A length extension direction of each of the rail and the elastic members is parallel to the height direction of the housing body. The at least one heating module is disposed in the accommodation space, and the at least one heating module includes a induction heating coil and a control circuit. The induction heating coil is disposed on the rail and is configured to move along the rail. The induction heating coil is supported by the elastic members, and the induction heating coil is held in the predetermined position to abut against the at least one gastronorm pan by elastic force generated from the elastic members. The control circuit is electrically coupled to the induction heating coil, and the control circuit is configured to control the induction heating coil to heat the at least one gastronorm pan.

In one of the possible or preferred embodiments, the gastronorm pans heating device includes a limiting module. The limiting module is fixed on the housing body and is located in the accommodation space. The rail includes a shallow pan section and a deep pan section that is away from the opening structure along the height direction, and a side surface of the induction heating coil away from the opening structure has a hook structure. When the induction heating coil is located in the deep pan section, the hook structure is configured to detachably connect with the limiting module to maintain the induction heating coil in the deep pan section.

In one of the possible or preferred embodiments, the housing body has two stepped walls in the accommodation space, and the two stepped walls has a plurality of setting holes. Each of the setting holes corresponds in position to the elastic members, respectively, and each of the elastic members includes an inner sleeve, a support structure, and a compression spring. The inner sleeve is located on a side surface of one of the two stepped walls facing the opening structure. The inner sleeve is disposed on an outer edge of one of the setting holes, and the inner sleeve includes a tubular portion and a ring portion. A part of the tubular portion passes through the setting hole. The ring portion is connected to the tubular portion. An outer diameter of the ring portion is greater than an inner diameter of the setting hole, and the inner sleeve abuts against the stepped wall through the ring portion. The support structure includes a shaft and a support head. The shaft passes through the inner sleeve and the setting hole, and the support head is fixed on an end of the shaft away from the inner sleeve. The compression spring is sleeved on the inner sleeve and the shaft. Two ends of the compression spring respectively press against the support head and the ring portion, such that the support head is configured to abut against the induction heating coil by elastic force generated from the compression spring.

In one of the possible or preferred embodiments, a length of the compression spring along the height direction is greater than a length of a part of the inner sleeve facing the support head and along the height direction. When the support head is adjacent to the tubular portion, the induction heating coil is located in the deep pan section.

In one of the possible or preferred embodiments, each of the two stepped walls includes a first platform portion, a second platform portion, a first wall portion, and a second wall portion. The first wall portion extends from one of two ends of the first platform portion along a direction towards the opening structure, the second wall portion extends from another one of the two ends of the first platform portion along a direction away from the opening structure, and the second platform portion extends from one end of the second wall portion along a direction away from a center of the accommodation space. The first platform portion has the setting holes, and a length of the second wall portion along the height direction is less than a length of the support structure along the height direction.

In one of the possible or preferred embodiments, when the shaft abuts against the second platform portion, the induction heating coil is located at a boundary position of the deep pan section.

In one of the possible or preferred embodiments, each of the elastic members includes an outer sleeve. The outer sleeve is located on the side surface of the stepped wall facing the opening structure. The outer sleeve is sleeved on an outer edge of the ring portion, and an inner diameter of the outer sleeve is greater than an outer diameter of the compression spring, such that the compression spring is located between the outer sleeve and the inner sleeve.

In one of the possible or preferred embodiments, a length of the compression spring along the height direction is greater than a length of the outer sleeve along the height direction. When the support head is adjacent to the outer sleeve, the induction heating coil is located in the deep pan section.

In one of the possible or preferred embodiments, the housing body has two stepped walls in the accommodation space, and each of the two stepped walls has a plurality of setting holes. Each of the setting holes corresponds in position to one of the elastic members, and includes a support structure and a compression spring. The support structure includes a shaft and a support head. The shaft passes through one of the setting holes, and the support head is fixed on an end of the shaft away from the inner sleeve. The compression spring is sleeved on the shaft. Two ends of the compression spring respectively press against the support head and the stepped wall, such that the support head is configured to abut against the at least one gastronorm pan by elastic force generated from the compression spring.

In one of the possible or preferred embodiments, each of the two stepped walls includes a first platform portion, a second platform portion, a first wall portion, and a second wall portion. The first wall portion extends from one of two ends of the first platform portion along a direction towards the opening structure, the second wall portion extends from another one of the two ends of the first platform portion along a direction away from the opening structure, and the second platform portion extends from one end of the second wall portion along a direction away from a center of the accommodation space. The first platform portion has the setting holes, and a length of the second wall portion along the height direction is less than a length of the support structure along the height direction. When the shaft abuts against the second platform portion, the induction heating coil is located at a boundary position of a deep pan section of the rail.

Therefore, in the gastronorm pans heating device provided by the present disclosure, by virtue of “a length extension direction of each of the rail and the elastic members being parallel to the height direction of the housing body,” and “the induction heating coil being supported by the elastic members, and the induction heating coil being held in the predetermined position to abut against the at least one gastronorm pan by elastic force generated from the elastic members,” the dinner the gastronorm pans heating device can adapt to various sizes of the gastronorm pan by automatically adjusting a position of the induction heating coil according to a depth of the gastronorm pan.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view showing two gastronorm pans being installed on a gastronorm pans heating device according to the present disclosure;

FIG. 2 is a schematic perspective view showing the two gastronorm pan being separated from the gastronorm pans heating device according to the present disclosure;

FIG. 3 is a schematic cross-sectional view taken along line III-III of FIG. 1;

FIG. 4 is a schematic cross-sectional view taken along line IV-IV of FIG. 1;

FIG. 5 is a schematic enlarged view of section V of FIG. 4;

FIG. 6 is a schematic cross-sectional view taken along line VI-VI of FIG. 1;

FIG. 7 is a schematic enlarged view of section VII of FIG. 6;

FIG. 8 is a schematic cross-sectional view showing a gastronorm pan being placed in the gastronorm pans heating device according to the present disclosure; and

FIG. 9 is another schematic cross-sectional view showing the gastronorm pan being placed in the gastronorm pans heating device according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

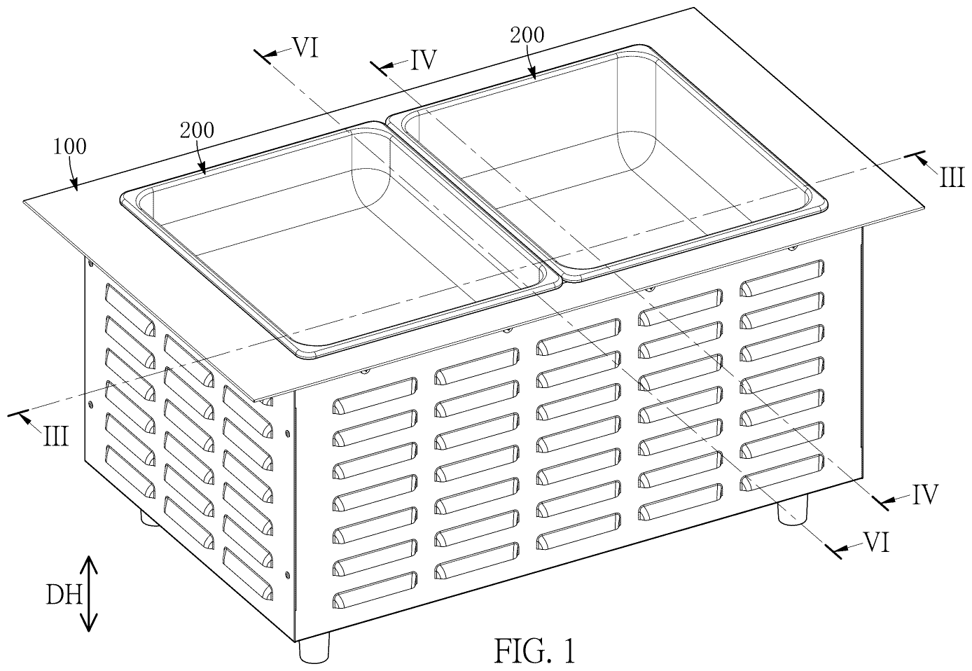

Referring to FIG. 1 to FIG. 9, the present disclosure provides a gastronorm pans heating device 100. As shown in FIG. 1, the dining pot heating equipment 100 includes a housing body 1, a rail 2 and a plurality of elastic members 3 disposed in the housing body 1, and at least one heating module 4 that is installed on the rail 2. The at least one heating module 4 can move along the rail 2, and a height position of the at least one heating module 4 can be automatically adjusted through the elastic members 3, so as to be adapted to at least one gastronorm pan 200 of different depths. The following description describes the structure and connection relation of each of the components of the dining pot heating equipment 100.

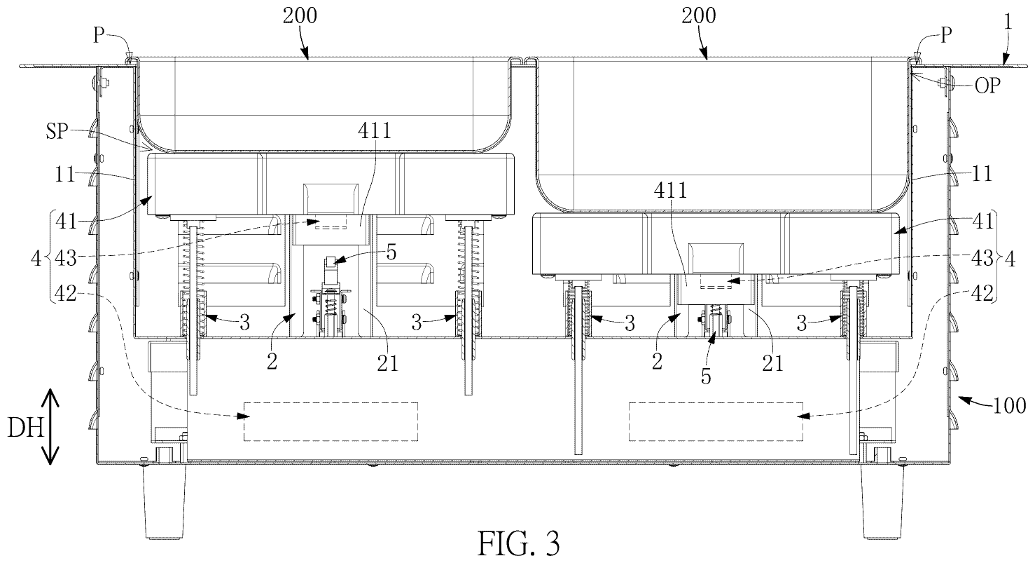

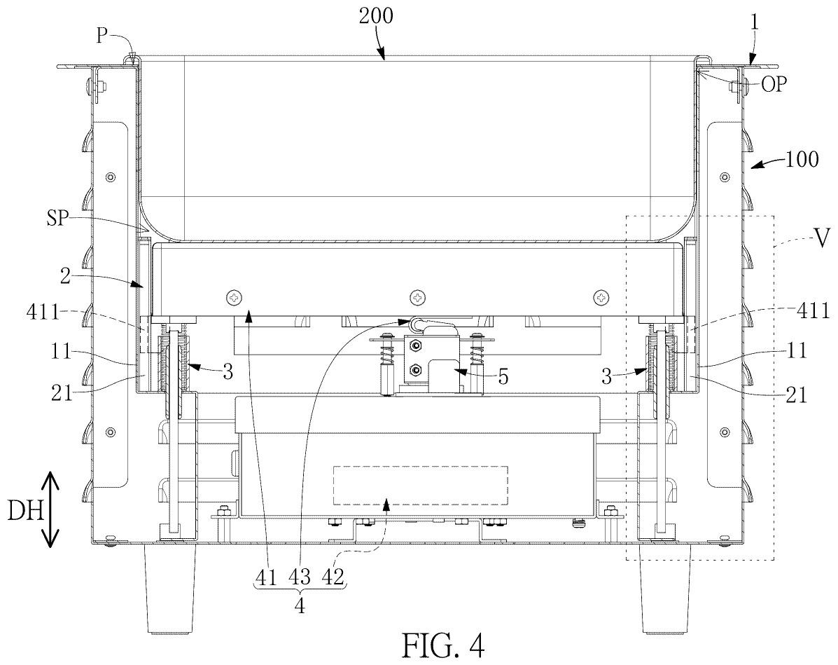

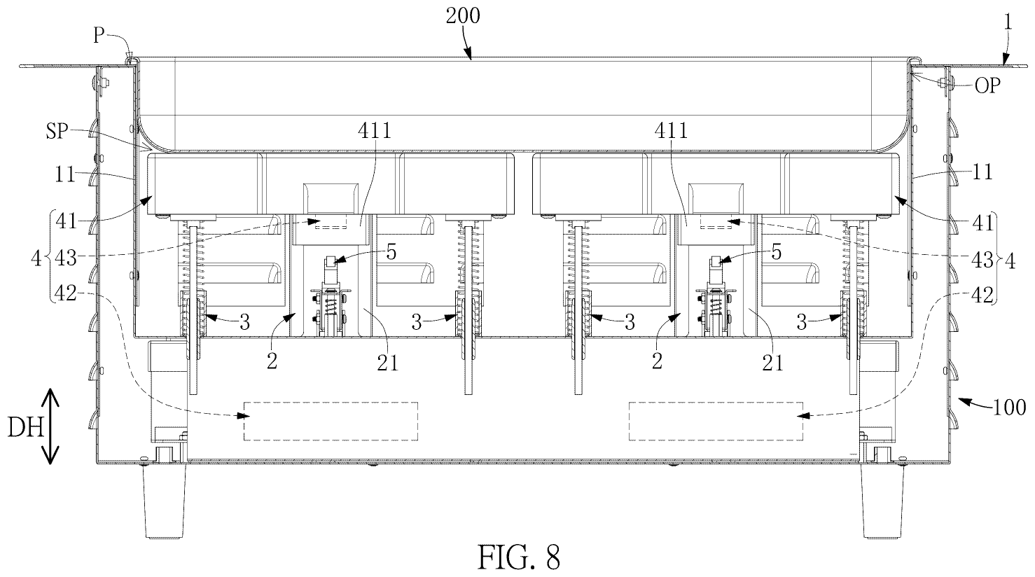

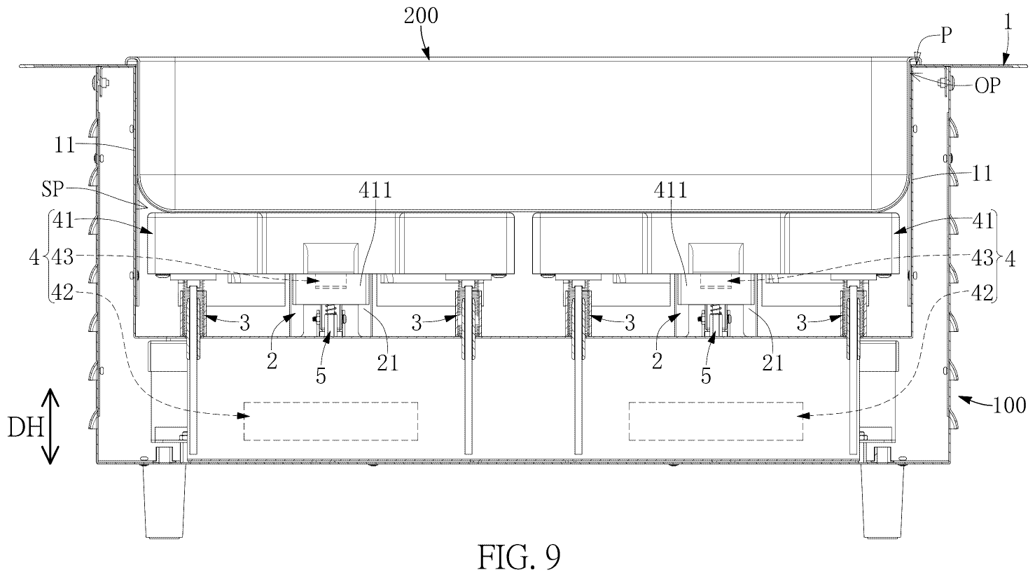

Referring to FIG. 1 to FIG. 3, the housing body 1 in the present embodiment is a box structure, and the housing body 1 has an accommodation space SP and a height direction DH. The housing body 1 has an opening structure OP that is located on a top surface of the housing body 1 in the height direction DH, and the opening structure OP is in spatial communication with the accommodation space SP. The opening structure OP can allow the at least one gastronorm pan 200 to be placed in a predetermined position P. In other words, the opening structure OP can allow a gastronorm pan 200 (as shown in FIG. 8 and FIG. 9) or a plurality of gastronorm pans 200 (as shown in FIG. 3 and FIG. 4) to be placed in the predetermined position P. For convenience of description, a quantity of the at least one gastronorm pan 200 is exemplified to be one.

In addition, when the gastronorm pan 200 is located in the predetermined position P, a top edge of the gastronorm pan 200 abuts against an outer edge of the opening structure OP, such that a part of the gastronorm pan 200 is accommodated in the accommodation space SP. In other words, the predetermined position P can be understood as a position where the gastronorm pan 200 is approximately co-planar with the housing body 1, that is, the gastronorm pan 200 does not protrude outside the opening structure OP after being placed at the predetermined position P.

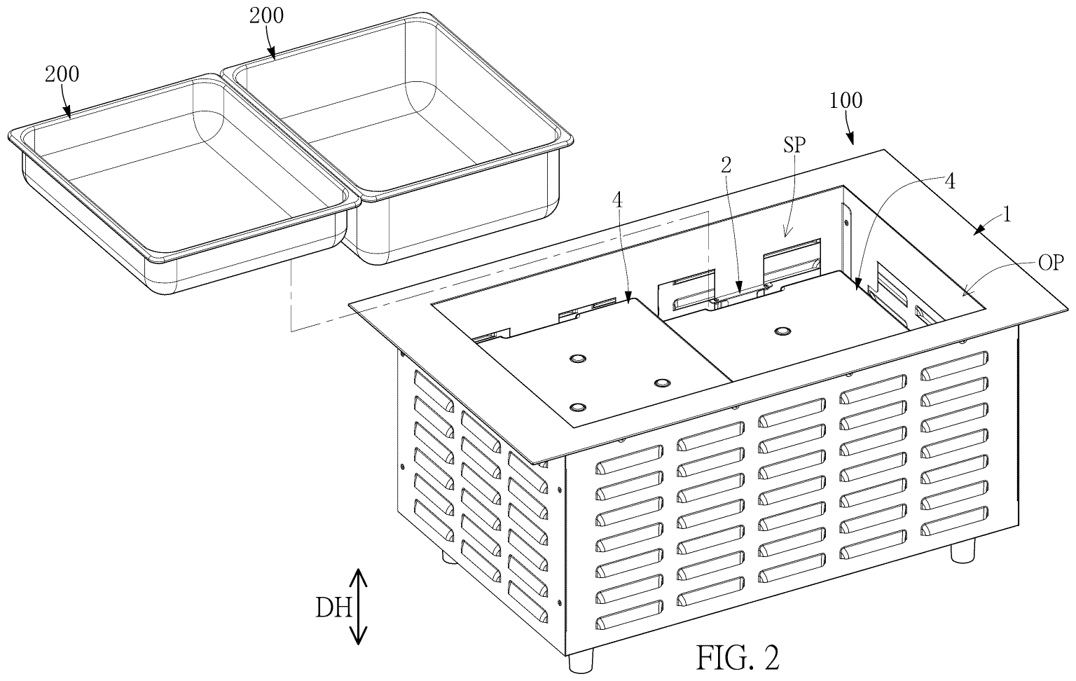

Referring to FIG. 2 to FIG. 4, the rail 2 and the elastic members 3 are disposed in the accommodation space SP, and a length extension direction of each of the rail 2 and the elastic members 3 is parallel to the height direction DH of the housing body 1.

Moreover, as shown in FIG. 4 to FIG. 6, the at least one heating module 4 is disposed in the accommodation space SP, and the at least one heating module 4 includes a induction heating coil 41 and a control circuit 42 that is electrically coupled to the induction heating coil 41. The induction heating coil 41 is disposed on the rail 2 and can move along the rail 2. The induction heating coil 41 is supported by the elastic members 3, and the induction heating coil 41 is held in the predetermined position P to abut against the gastronorm pan 200 by elastic force generated from the elastic members 3. Accordingly, the elastic members 3 as described can cooperate with the rail 2 to achieve a purpose of enabling the induction heating coil 41 to automatically adapt to different depths of the gastronorm pans and heat the gastronorm pans simultaneously. In other words, practically, the rail 2 includes a shallow pan section R1 and a deep pan section R2 that are defined along the height direction DH, and the deep pan section R2 is away from the opening structure OP. The induction heating coil 41 installed on the rail 2 can cooperate with the elastic members 3 to move between the shallow pan section R1 and the deep pan section R2.

It should be noted that, the gastronorm pans heating device 100 in the present embodiment of FIG. 2 to FIG. 9 has two heating modules 4, but the present disclosure is not limited thereto. In addition, in order to understand the present disclosure more clearly, one embodiment of the gastronorm pans heating device 100 will be described in detail below.

In the present embodiment, as shown in FIG. 3 to FIG. 5, the housing body 1 also includes two stepped walls 11 that are installed in the accommodation space SP and are spaced apart from each other. Each of the two stepped walls 11 includes a first platform portion 111, a second platform portion 112, a first wall portion 113, and a second wall portion 114.

The first wall portion 113 extends from one of two ends of the first platform portion 111 along a direction towards the opening structure OP, the second wall portion 114 extends from another one of the two ends of the first platform portion 111 along a direction away from the opening structure OP, and the second platform portion 112 extends from one end of the second wall portion 114 along a direction away from a center of the accommodation space SP. Accordingly, the two stepped walls 11 can be used to install the rail 2 and the elastic members 3.

In addition, in order to install the two heating modules 4, the rail 2 also includes four chute structures 21, and the four chute structures 21 are disposed on the first platform portion 111 of the two stepped walls 11. The induction heating coil 41 of each of the two heating modules 4 has two side bumps 411, and the two side bumps 411 of the induction heating coil 41 can be slidably disposed on two of the four chute structures 21, such that the induction heating coil 41 can move along two corresponding ones of the four chute structures 21.

Moreover, each of the two stepped walls 11 also has a plurality of setting holes 115 located on the first platform portion 111. Each of the setting holes 115 preferably corresponds in position to each of four corners of the induction heating coil 41, and each of the setting holes 115 can allow one of the elastic members 3 to install therein, so as to ensure that the two induction heating coils 41 can be stably pushed toward the opening structure OP by the elastic members 3.

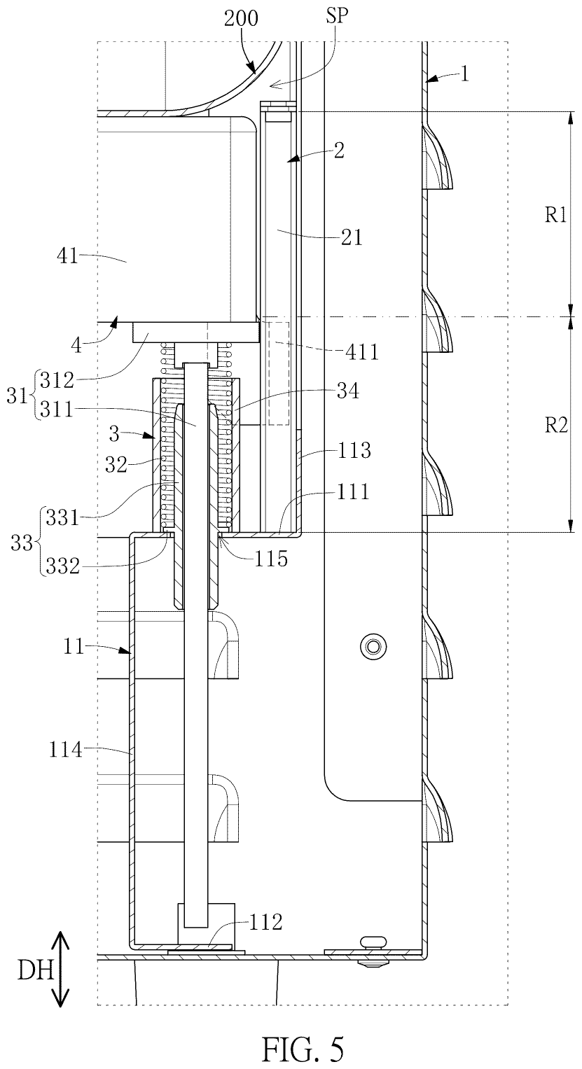

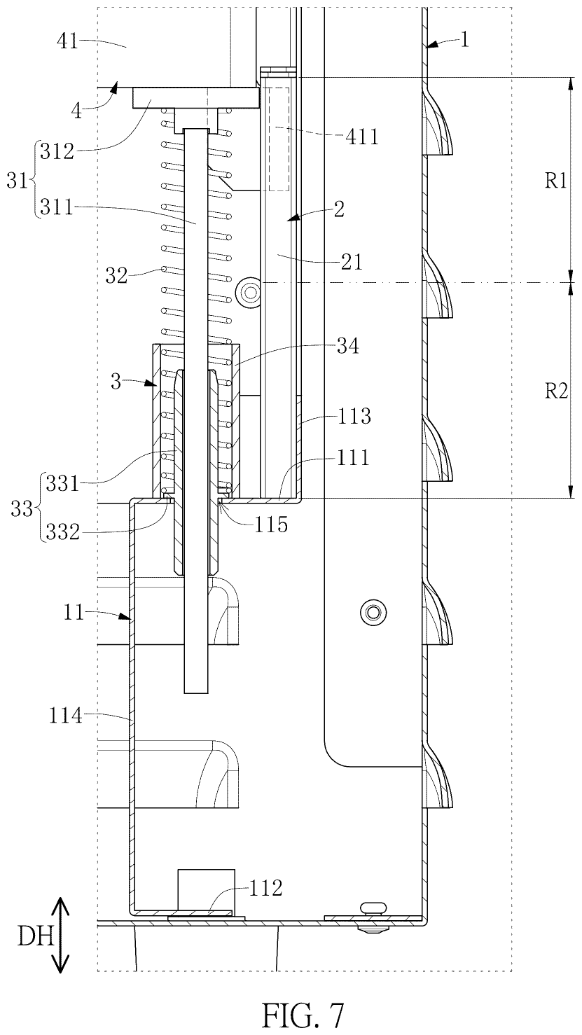

Referring to FIG. 5 and FIG. 7, each of the elastic members 3 includes a support structure 31 and a compression spring 32 sleeved on the support structure 31. The support structure 31 includes a shaft 311 and a support head 312, the shaft 311 passes through the setting hole 115, and the support head 312 is fixed on an end of the shaft 311 away from the setting hole 115. Furthermore, the compression spring 32 is sleeved on the shaft 311, and two ends of the compression spring 32 respectively press against the support head 312 and one of the two stepped walls 11, such that the support head 312 is can abut against the induction heating coil 41 by elastic force generated from the compression spring 32.

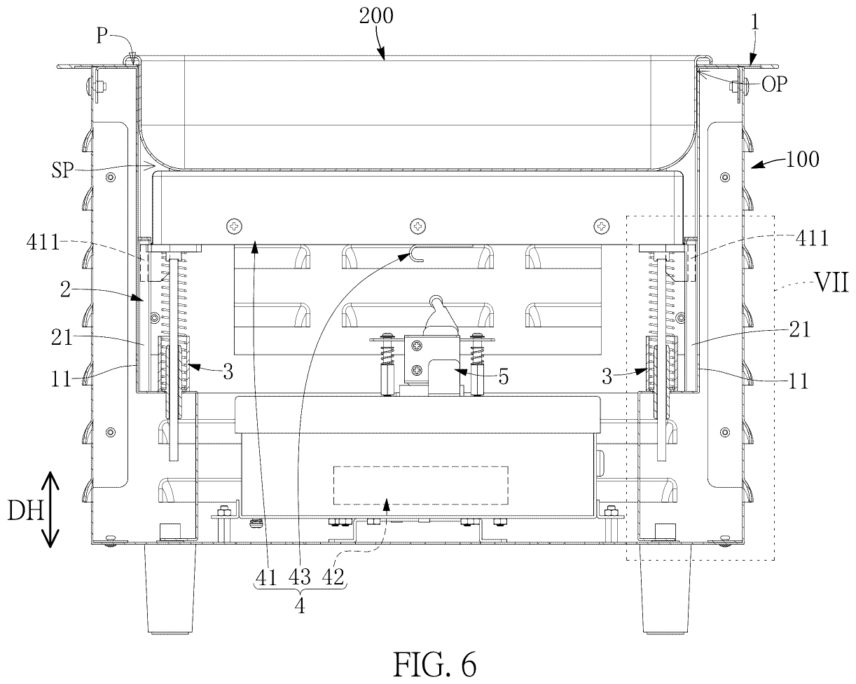

It is worth noting that, when the induction heating coil 41 is in the deep pan section R2, the elastic members 3 are greatly squeezed, such that the elastic force generated by the elastic members 3 will be greatly increased. However, when a total weight on each of the two induction heating coils 41 (i.e., a total weight of the gastronorm pan and food in the gastronorm pan) is less than the aforementioned elastic force, the gastronorm pan 200 cannot be maintained at the predetermined position P. Therefore, as shown in FIG. 4 and FIG. 6, the dining pot heating equipment 100 may further include a limiting module 5, each of the two induction heating coils 41 has a hook structure 43 that can cooperate with the limiting module 5, and the hook structure 43 is located on a side surface of each of the two induction heating coils 41 away from the opening structure OP. Accordingly, when each of the two induction heating coils 41 is located in the deep pan section R2, the hook structure 43 can detachably connect with the limiting module 5, such that the two induction heating coils 41 are maintained in the deep pan section R2.

In practice, the hook structure 43 may include a shell, and a torsion spring and a hook block that are disposed in the shell. The hook block is pivotally connected in the shell and is resisted by the torsion spring, and the hook block can move between a hook position and an unlocking position through the torsion spring. The hook structure 43 is a technology well known to those skilled in the art, and will not be described in detail herein.

In addition, in order to avoid excessive displacement of the two induction heating coils 41 due to elastic fatigue, a length of the second wall portion 114 along the height direction DH is preferably designed to be less than a length of the support structure 31 along the height direction DH. Accordingly, when the shaft 311 abuts against the second platform portion 112, the induction heating coil 41 is located at a boundary position of the deep pan section R2.

In another embodiment, as shown in FIG. 5 and FIG. 7, each of the elastic members 3 of the gastronorm pans heating device 100 further includes an inner sleeve 33, and the inner sleeve 33 can assist the compression spring 32 to stably move on the support structure 31.

Specifically, the inner sleeve 33 is located on a side surface of the stepped wall 11 facing the opening structure OP (i.e., the first platform portion 111), and the inner sleeve 33 is disposed on the outer edge of the setting hole 115. The inner sleeve 33 includes a tubular portion 331 and a ring portion 332 connected to the tubular portion 331. The tubular portion 331 is sleeved on the shaft 311 of the support structure 31, and a part of the tubular portion 331 passes through the setting hole 115.

In addition, an outer diameter of the tubular portion 331 is within a range of from an inner diameter of the setting hole 115 to an inner diameter of the compression spring 32, such that a predetermined gap is maintained between the tubular portion 331 and the compression spring 32. Moreover, the length of the compression spring 32 along the height direction DH is greater than the length of the inner sleeve 33 facing a side of the support head 312 and along the height direction DH. Accordingly, the compression spring 32 can compress and expand along the shaft 311 more smoothly through the predetermined gap.

Furthermore, an outer diameter of the ring portion 332 is greater than the inner diameter of the setting hole 115, such that the inner sleeve 33 can abut against the stepped wall 11 through the ring portion 332. Accordingly, the compression spring 32 can be sleeved on the tubular portion 331 of the inner sleeve 33, and two ends of the compression spring 32 respectively abut against the support head 312 and the ring portion 332.

Preferably, each of the elastic members 3 may further include an outer sleeve 34, and a length of the outer sleeve 34 along the height direction DH is less than the length of the compression spring 32 along the height direction DH. The outer sleeve 34 is located on a side surface of the stepped wall 11 facing the opening structure OP (i.e., the first platform portion 111), and the outer sleeve 34 is sleeved on the outer edge of the ring portion 332.

The inner diameter of the outer sleeve 34 is greater than the outer diameter of the compression spring 32, such that the compression spring 32 can be located between the outer sleeve 34 and the inner sleeve 33. Accordingly, when the induction heating coil 41 is located in the deep pan section R2, the outer sleeve 34 can prevent the compression spring 32 from deflecting during the compression process.

### Beneficial Effects of the Embodiment

In conclusion, in the gastronorm pans heating device provided by the present disclosure, by virtue of “a length extension direction of each of the rail and the elastic members being parallel to the height direction of the housing body,” and “the induction heating coil being supported by the elastic members, and the induction heating coil being held in the predetermined position to abut against the at least one gastronorm pan by elastic force generated from the elastic members,” the dinner the gastronorm pans heating device can adapt to various sizes of the gastronorm pan by automatically adjusting a position of the induction heating coil according to a depth of the gastronorm pan.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A gastronorm pans heating device, comprising:
a housing body having an accommodation space and a height direction, wherein the housing body has an opening structure that is in spatial communication with the accommodation space; wherein the opening structure is configured to allow at least one gastronorm pan to be placed in a predetermined position; wherein, when the at least one gastronorm pan is located at the predetermined position, a top edge of the at least one gastronorm pan abuts against an outer edge of the opening structure, such that a part of the at least one gastronorm pan is accommodated in the accommodation space;
a rail and a plurality of elastic members disposed in the accommodation space, wherein a length extension direction of each of the rail and the elastic members is parallel to the height direction of the housing body; and
at least one heating module disposed in the accommodation space, wherein the at least one heating module includes:
a induction heating coil disposed on the rail and being configured to move along the rail, wherein the induction heating coil is supported by the elastic members, and the induction heating coil is held in the predetermined position to abut against the at least one gastronorm pan by elastic force generated from the elastic members; and
a control circuit electrically coupled to the induction heating coil, wherein the control circuit is configured to control the induction heating coil to heat the at least one gastronorm pan.

2. The gastronorm pans heating device according to claim 1, further comprising a limiting module; wherein the limiting module is fixed on the housing body and is located in the accommodation space; wherein the rail includes a shallow pan section and a deep pan section that is away from the opening structure along the height direction, and a side surface of the induction heating coil away from the opening structure has a hook structure; wherein, when the induction heating coil is located in the deep pan section, the hook structure is configured to detachably connect with the limiting module to maintain the induction heating coil in the deep pan section.

3. The gastronorm pans heating device according to claim 2, wherein the housing body has two stepped walls in the accommodation space, and each of the two stepped walls has a plurality of setting holes; wherein the setting holes corresponds in position to the elastic members, respectively, and each of the elastic members includes:
an inner sleeve located on a side surface of one of the two stepped walls facing the opening structure, wherein the inner sleeve is disposed on an outer edge of one of the setting holes, and the inner sleeve includes:
a tubular portion, wherein a part of the tubular portion passes through the setting hole; and
a ring portion connected to the tubular portion, wherein an outer diameter of the ring portion is greater than an inner diameter of the setting hole, and the inner sleeve abuts against the stepped wall through the ring portion;
a support structure including a shaft and a support head, wherein the shaft passes through the inner sleeve and the setting hole, and the support head is fixed on an end of the shaft away from the inner sleeve; and
a compression spring sleeved on the inner sleeve and the shaft, wherein two ends of the compression spring respectively press against the support head and the ring portion, such that the support head is configured to abut against the induction heating coil by elastic force generated from the compression spring.

4. The gastronorm pans heating device according to claim 3, wherein a length of the compression spring along the height direction is greater than a length of a part of the inner sleeve facing the support head and along the height direction; wherein, when the support head is adjacent to the tubular portion, the induction heating coil is located in the deep pan section.

5. The gastronorm pans heating device according to claim 3, wherein each of the two stepped walls includes a first platform portion, a second platform portion, a first wall portion, and a second wall portion; wherein the first wall portion extends from one of two ends of the first platform portion along a direction towards the opening structure, the second wall portion extends from another one of the two ends of the first platform portion along a direction away from the opening structure, and the second platform portion extends from one end of the second wall portion along a direction away from a center of the accommodation space; wherein the first platform portion has the setting holes, and a length of the second wall portion along the height direction is less than a length of the support structure along the height direction.

6. The gastronorm pans heating device according to claim 5, wherein, when the shaft abuts against the second platform portion, the induction heating coil is located at a boundary position of the deep pan section.

7. The gastronorm pans heating device according to claim 3, wherein each of the elastic members includes:
an outer sleeve located on the side surface of the stepped wall facing the opening structure, wherein the outer sleeve is sleeved on an outer edge of the ring portion, and an inner diameter of the outer sleeve is greater than an outer diameter of the compression spring, such that the compression spring is located between the outer sleeve and the inner sleeve.

8. The gastronorm pans heating device according to claim 7, wherein a length of the compression spring along the height direction is greater than a length of the outer sleeve along the height direction; wherein, when the support head is adjacent to the outer sleeve, the induction heating coil is located in the deep pan section.

9. The gastronorm pans heating device according to claim 1, wherein the housing body has two stepped walls in the accommodation space, and each of the two stepped walls has a plurality of setting holes; wherein each of the setting holes corresponds in position to one of the elastic members, and each of the elastic members includes:
a support structure including a shaft and a support head, wherein the shaft passes through one of the setting holes, and the support head is fixed on an end of the shaft away from the inner sleeve; and
a compression spring sleeved on the shaft, wherein two ends of the compression spring respectively press against the support head and the stepped wall, such that the support head is configured to abut against the at least one gastronorm pan by elastic force generated from the compression spring.

10. The gastronorm pans heating device according to claim 9, wherein each of the two stepped walls includes a first platform portion, a second platform portion, a first wall portion, and a second wall portion; wherein the first wall portion extends from one of two ends of the first platform portion along a direction towards the opening structure, the second wall portion extends from another one of the two ends of the first platform portion along a direction away from the opening structure, and the second platform portion extends from one end of the second wall portion along a direction away from a center of the accommodation space; wherein the first platform portion has the setting holes, and a length of the second wall portion along the height direction is less than a length of the support structure along the height direction; wherein, when the shaft abuts against the second platform portion, the induction heating coil is located at a boundary position of a deep pan section of the rail.
